(19) United States
(12) Patent Application Publication
(10) Pub. No.: US 2021/0226365 A1
(43) Pub. Date: Jul. 22, 2021

(54) FIXATION STRUCTURE FOR THERMAL PRINTING HEAD

(71) Applicant: CHIEN HWA COATING TECHNOLOGY, INC., HSINCHU CITY (TW)

(72) Inventors: YULUNG TSAO, HSINCHU CITY (TW); YIWEI LIN, HSINCHU CITY (TW); CHUNCHEN CHEN, HSINCHU CITY (TW)

(21) Appl. No.: 16/884,111

(22) Filed: May 27, 2020

(30) Foreign Application Priority Data
Jan. 17, 2020 (TW) 109101620

(51) Int. Cl. H01R 12/71; H01R 13/639; B41J 2/335; B41J 2/355

(52) U.S. Cl. CPC H01R 12/71; B41J 2/355; B41J 2/33505; H01R 13/639

(57) ABSTRACT

The present application provides a fixation structure for a thermal printing head, and the fixation structure comprises a first circuit board, a first fixation member disposed on one side of the first circuit board, and a second circuit board. A first slot is formed between the first fixation member and the first circuit board. A first limited member and a second limited member are disposed on both ends of the first fixation member with a first protruded member and a second protruded member disposed slidably on one side of both respectively. The second circuit board is disposed slidably between the first limited member and the second limited member and inserted to the first slot. This structure facilitates rapid installation of circuit boards. Furthermore, a first locking slot may be capable of rotating and disposed inside the first fixation member for providing rapid installation of circuit boards.

### FIELD OF THE INVENTION

The present application relates generally to a fixation structure for a thermal printing head, and particularly to a fixation structure facilitating rapid installation of a printing-head circuit board.

### BACKGROUND OF THE INVENTION

As technologies and the commerce develop, invoices or receipts are required while paying the bill. The vendors thereby install printers to cash registers. In particular, thermal printers are popular products adopted extensively in the retail, catering, or transportation industries for printing receipts, price tags, and transportation details. As the application scope of printing devices extends, various printing media used by users are developed. In particular, the small-sized thermal printers are most popular. The device uses thermal paper for printing.

The thermal paper is formed by smearing chemical materials on paper. Then the color of the paper can be changed by heating without using ink. The thermal paper can be used in thermal printers, particularly lightweight and small devices such as fax machine, addometers, cash registers, and credit-card terminals, and making the cost lower.

To replace the thermal printing head (TPH) according to the prior art, since the inside space of the printer is narrow, complicated disassembling steps are required. The process is time-consuming and the disassembled parts tend to fall or lose. Accordingly, to solve the above problems, it is highly required to have a design of the fixation structure that can facilitate rapid installation of thermal printing heads.

In view of the above problems according to the prior art, the present application provides a fixation structure for thermal printing head, which uses a fixation member to dispose a board member, such as a printed circuit board or a lid, on one side. The circuit board is inserted to the fixation member. Then two limited members are disposed on both side of the fixation member. Two protruded members are disposed slidably on the two limited members for installing the circuit board rapidly. In addition, the two limited members also fix the circuit board. Thereby, the problem of complicated and time-consuming steps for installing the circuit board to the printer according to the prior art can be solved. According to the present application, a rotatable locking slot is further disposed inside the fixation member for providing another structure for installing the circuit board rapidly.

### SUMMARY

An objective of the present application is to provide a fixation structure for a thermal printing head, which comprises a fixation member on one side of a first circuit board. The fixation member is inserted by a second circuit board. Two limited members are disposed on both sides of the fixation member. By using two protruded members disposed slidably at the two limited members, the second circuit board can by installed rapidly. Meanwhile, the two limited members fix the second circuit board.

Another objective of the present application is to provide a fixation structure for a thermal printing head. The fixation member is disposed on one side of the circuit board. A locking slot is connected pivotally inside the fixation member. The second circuit board is inserted to the locking slot. A fixation opening is disposed on the top of the second circuit board and corresponding to the location of a hole. By using the locking slot connected pivotally at the fixation member, the circuit is moved for installing the second circuit board rapidly. In addition, a screw member passes through the fixation opening and the hole for fixing the second circuit board.

A further objective of the present application is to provide a fixation structure for a thermal printing head. A second fixation member is disposed on one side of a board member. The first circuit board is inserted to the second fixation member. The fixation member is disposed on one side of the first fixation board. The second circuit board is inserted to the first fixation member. Then an output terminal is connected electrically to the first circuit board and the second circuit board. By this structure, the signals from the larger second circuit board is transmitted to the smaller first circuit board. Thereby, the fixation structure for thermal printing head can adapt to different sizes of circuit boards and thus achieving the efficacy of rapid installation.

To achieve the above objectives and efficacies, the present application provides a fixation structure for a thermal printing head, which comprises a first printed circuit board, a first fixation member, and a second circuit board. The first fixation member is disposed on one side of the first circuit board. A first lot of formed between the first fixation member and the first circuit board. A first output terminal is disposed inside the first slot. A first limited member is disposed on one end of the first fixation member. A second limited member is disposed on the other end of the first fixation member. A first protruded member is disposed slidably on the top of the side of the first limited member facing the second limited member. A second protruded member is disposed slidably on the top of the side of the second limited member facing the first limited member. The second circuit board is disposed slidably between the first limited member and the second limited member and inserted to the first slot of the first fixation member. A first input terminal is disposed on one end of the second circuit. The first input terminal is connected electrically to the first output terminal. The second circuit board slides down to the top of the first fixation member from the place between a top of the first limited member and a top of the second limited member. The first protruded member and the second protruded member slide facing the board member to a top of the first circuit board. The first output terminal transmits a control signal to the first input terminal. By using this fixation structure, the first circuit board can be installed rapidly and fixed to the board member.

To achieve the above objectives and efficacies, the present application provides a fixation structure for thermal printing head, which comprises a first printed circuit board, a first fixation member, and a second circuit board. A first hole is disposed on one side of the first circuit board. The first fixation member is disposed on one side of the first circuit board. A first locking slot is disposed pivotally inside the first fixation member. A first output terminal is disposed inside the first locking slot. One end of the second circuit board is inserted to the inside of the first locking slot. A first fixation cut-opening is disposed on the top of the second circuit board and corresponding to the location of the first hole. A first input terminal is disposed on one end of the second circuit board. The first input terminal is connected electrically to the first output terminal. The end of the second circuit board is inserted into the first locking slot at an angle. The first locking slot rotates inside the first fixation member for moving the second circuit board and enabling the first fixation cut-opening to correspond to the first hole. The first output terminal transmits a control signal to the first input terminal. By using the rotatable first locking slot, the first circuit board can be installed rapidly and fixed to the board member.

According to an embodiment of the present application, a heating device is disposed on one side of the second circuit board. The heating device is connected electrically to the first input terminal and receives the control signal.

According to an embodiment of the present application, the fixation structure for thermal printing head is disposed on one side of a board member. The fixation structure for thermal printing head further comprises a second fixation member disposed on one side the board member. A second slot is formed between the second fixation member and the board member. A third limited member is disposed on one end of the second fixation member. A fourth limited member is disposed on the other end of the second fixation member. A third protruded member is disposed slidably on the top of the side of the third limited member facing the fourth limited member. A fourth protruded member is disposed slidably on the top of the side of the fourth limited member facing the third limited member. The first circuit board is disposed slidably between the third limited member and the fourth limited member and inserted to the second slot of the second fixation member.

According to an embodiment of the present application, the fixation structure for thermal printing head is disposed on one side of a board member. The fixation structure for thermal printing head further comprises a second fixation member disposed on one side the board member. A second slot is formed between the second fixation member and the board member. A third limited member is disposed on one end of the second fixation member. A fourth limited member is disposed on the other end of the second fixation member. A third protruded member is disposed slidably at the middle of the side of the third limited member facing the fourth limited member. A fourth protruded member is disposed slidably at the middle of the side of the fourth limited member facing the third limited member. The first circuit board is disposed slidably between the third limited member and the fourth limited member and inserted to the second slot of the second fixation member. Two second recesses are disposed on both ends of the first circuit board and corresponding to the locations of the third protruded member and the fourth protruded member.

According to an embodiment of the present application, a second input terminal is disposed at the bottom of the first circuit board. A second output terminal is disposed at the second slot. The second input terminal is connected electrically to the second output terminal. The control signal is transmitted sequentially from the second output terminal to the second input terminal, from the second input terminal to the first output terminal, and from the first output terminal to the first input terminal.

According to an embodiment of the present application, the fixation structure for thermal printing head further comprises one or more pivot member. The first locking slot is connected pivotally to the inside of the first fixation member via the one or more pivot member.

According to an embodiment of the present application, the fixation structure for thermal printing head further comprises a first screw passing through the first fixation cut-opening and the first hole.

According to an embodiment of the present application, the fixation structure for thermal printing head further comprises a second fixation member and a second circuit board. The second fixation member is disposed on one side of the first fixation member. A second locking slot is disposed pivotally inside the second fixation member. One end of the second circuit board is inserted into the second locking slot. A second fixation cut-opening is disposed on the top of the second circuit board and corresponding to the location of the second hole.

According to an embodiment of the present application, the fixation structure for thermal printing head further comprises a second screw passing through the second fixation cut-opening and the second hole.

### BRIEF DESCRIPTION OF THE DRAWINGS

FIG. 1 shows a schematic diagram of the structure according to the first embodiment of the present application;

FIG. 2 shows a schematic diagram of the operation according to the first embodiment of the present application;

FIG. 3A shows a schematic diagram of the structure of the second fixation member according to the first embodiment of the present application;

FIG. 3B shows a schematic diagram of the operation of the second fixation member according to the first embodiment of the present application;

FIG. 4 shows a schematic diagram of the structure according to the second embodiment of the present application;

FIG. 5 shows a schematic diagram of the operation according to the second embodiment of the present application;

FIG. 6A shows a schematic diagram of the structure of the second fixation member according to the second embodiment of the present application; and

FIG. 6B shows a schematic diagram of the operation of the second fixation member according to the second embodiment of the present application.

### DETAILED DESCRIPTION

In order to make the structure and characteristics as well as the effectiveness of the present application to be further understood and recognized, the detailed description of the present application is provided as follows along with embodiments and accompanying figures.

The present application provides a fixation structure for thermal printing head, which fixes a second circuit board to a fixation member and two limited members of a first circuit board. By using the two limited members to fix the second circuit board, a structure for rapid installation of a circuit board can be provided. The present application further connects a first locking slot pivotally to an inner side of the first fixation member. By using the rotatable first locking slot, a structure for rapid installation of the second circuit board can be provided.

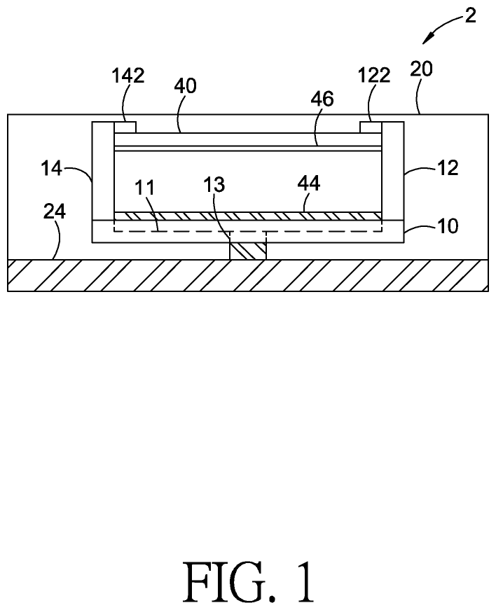

Please refer to FIG. 1, which shows a schematic diagram of the structure according to the first embodiment of the present application. As shown in the figure, the present embodiment provides a fixation structure for thermal printing head 2, which comprises a first circuit board 20, a first fixation member 10, and a second circuit board 40.

Please refer again to FIG. 1. As shown in the figure, according to the present embodiment, the first fixation member 10 is disposed on one side of the first circuit board 20. A first slot 11 is formed between the first fixation member 10 and the board member 1 for accommodating the second circuit board 40. A first output terminal 13 is disposed in an inner side of the first slot 11. A first limier 12 is disposed on one end of the first fixation member 10. A second limited member 14 is disposed on the other end of the first fixation member 10. A first protruded member 122 is disposed slidably on the top of the side of the first limited member 12 facing the second limited member 14. A second protruded member 142 is disposed slidably on the top of the side of the second limited member 14 facing the first limited member 12. The method for disposing the first and second protruded members 122, 142 slidably can refer to the operation of sliding tracks and protruded members according to the prior art. The details will not be described in this embodiment. The second circuit board 40 is disposed slidably between the first and second limited members 12, 14 and inserted into the first slot 11 of the first fixation member 10. According to the present embodiment, a first input terminal 44 is further disposed at the bottom of the second circuit board 40. The first input terminal 44 is connected electrically to the first output terminal 13. The first output terminal 13 transmits a control signal to the first input terminal 44.

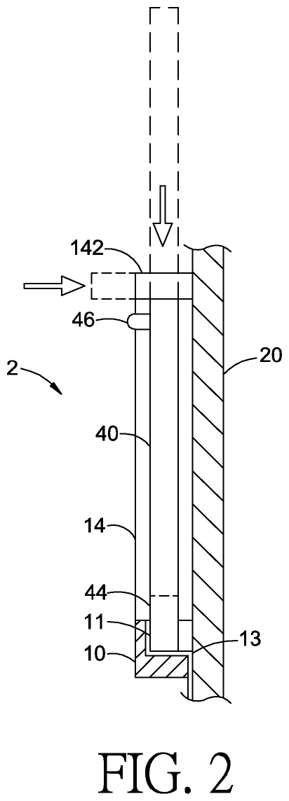

Please refer to FIG. 1 again and refer to FIG. 2 shows a schematic diagram of the operation according to the first embodiment of the present application. As shown in the figures, according to the present embodiment, the second circuit board 40 slides from a top of the first limited member 12 (not shown in FIG. 2) and a top of the second limited member 14 down to the top of the first fixation member 10. The first circuit board 14 is inserted inside and connected with the first slot 11. The first protruded member 122 and the second protruded member 142 slide facing the first circuit 20 to a top of the second circuit board 40. The first and second protruded members 122, 142 provide fixation for preventing arbitrary movement.

According to the present embodiment, a heating device 46 is disposed on one side of the second circuit board 40. The heating device 46 is connected electrically to the second circuit board 40 for receiving electrical energy and the control signal, and forming a structure of thermal printing head fixed by the structure according to the present embodiment. The first circuit board 20 can be a printed circuit board (PCB) according to the prior art.

According to the present embodiment, the first fixation member 10 is disposed on one side of the first circuit board 20. The second circuit board 40 is inserted to the first fixation member 10. By using the two limited members disposed on both sides of the first fixation member 10 and the two protruded members sliding and fixed on the top of the second circuit board 40, the structure can provide rapid installation of the second circuit board 40 and avoid up-and-down movement of the second circuit board 40.

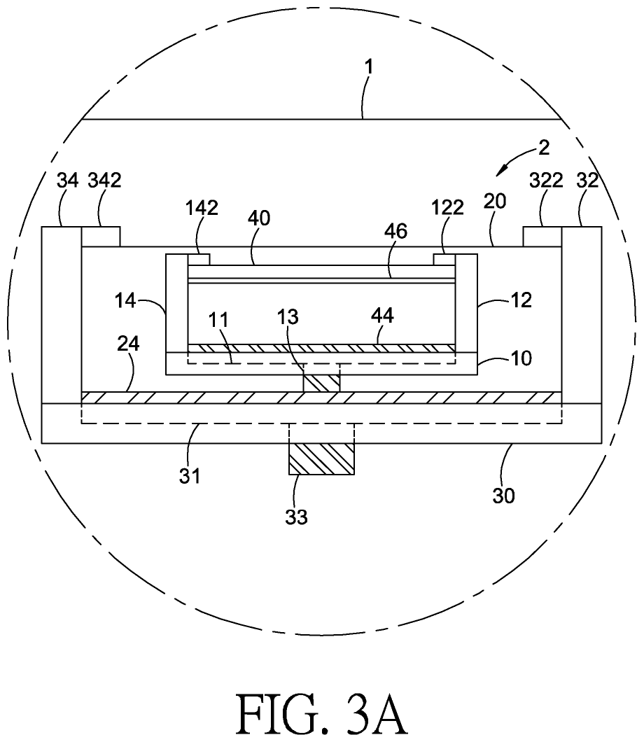

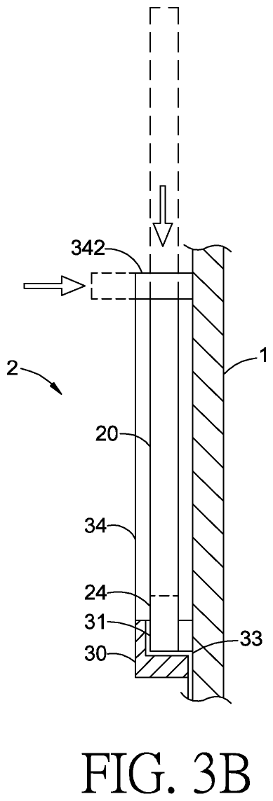

Please refer to FIG. 3A, which shows a schematic diagram of the structure of the second fixation member according to the first embodiment of the present application. As shown in the figure, the present embodiment is based on the structure according to the above embodiment. A second fixation member 30 is disposed on one side of a board member 1. In other word, the board member 1 is disposed on one side of the second fixation member 30. According to the present embodiment, the board member 1 is the lid of the printer. A second slot 31 is formed between the second fixation member 30 and the board member 1. A third limier 32 is disposed on one end of the second fixation member 30. A fourth limited member 34 is disposed on the other end of the second fixation member 30. A third protruded member 322 is disposed slidably on the top of the side of the third limited member 32 facing the fourth limited member 34. A fourth protruded member 342 is disposed slidably on the top of the side of the fourth limited member 34 facing the third limited member 32. The first circuit board 20 is disposed slidably between the third and fourth limited members 32, 34 and inserted into the second slot 31 of the second fixation member 30.

Please refer again to FIG. 2 and FIG. 3A, and refer to FIG. 3B. FIG. 3B shows a schematic diagram of the operation of the second fixation member according to the first embodiment of the present application. As shown in the figures, the operation according to the present embodiment is the same as the previous embodiment. As shown in FIG. 2, according to the present embodiment, the first circuit board 20 corresponds to the board member 1; the second fixation member 20 corresponds to the first fixation member 10; the third protruded member 322 corresponds to the first protruded member 122; the fourth protruded member 342 corresponds to the second protruded member 142; and the second circuit board 40 corresponds to the first circuit board 20. The heating device 46 moves along with the second circuit board 40. Since the above main devices have their corresponding devices, the operation of the devices will not be described again. The devices according to the present embodiment are duplicated from the ones according to the above embodiment and shrunk before installing on the first circuit board 20. Hence, the purpose of converting small-sized circuit boards to large ones can be achieved.

Next, the first input terminal 44 is disposed on one end of the second circuit board 40 and connected electrically to the second circuit board 40. The first slot 11 of the first fixation member 10 is disposed corresponding to the first input terminal 44 and connected electrically to the first output terminal 13. One end of the first circuit board 20 is disposed corresponding to the first output terminal 13 and connected electrically to a second input terminal 24. The board member 1 is disposed corresponding to the second input terminal 24 and connected electrically to a second output terminal 33. The control signal of the thermal printer is transmitted sequentially from the second output terminal 33 to the second input terminal 24, from the second input terminal 24 to the first output terminal 13, and finally from the first output terminal 13 to the first input terminal 44 for controlling the heating device 46 of the second circuit board 40. Then the signals on the large-sized first circuit board 20 can be adapted to the small-sized second circuit board 40. Thereby, the thermal printer can adapt to different sizes of circuit boards.

According to the present embodiment, the second fixation member 30 is disposed on one side of the board member 1. The first circuit board 20 is inserted to the second fixation member 30. By using the two limited members disposed on both sides of the second fixation member 30 and the two protruded members sliding and fixed on the top of the first circuit board 20, as well as using the first and second input terminals 44, 24 and the first and second output terminals 13, 33 to transmit signals, the heating device 46 of the second circuit board 40 can be controlled.

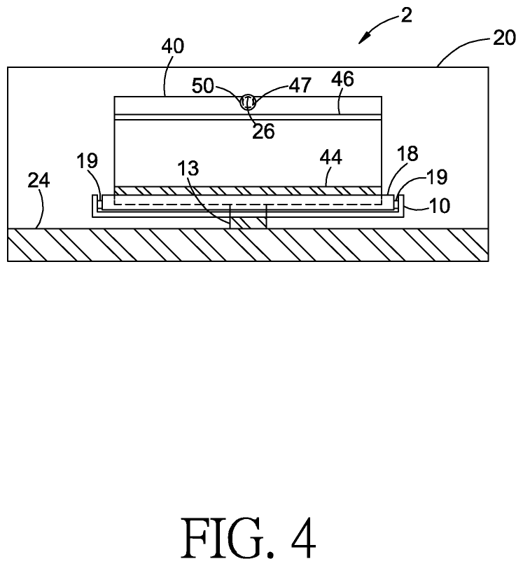

Please refer to FIG. 4, which shows a schematic diagram of the structure according to the second embodiment of the present application. As shown in the figure, the present embodiment provides a fixation structure for thermal printing head 2, which comprises a first circuit board 20, a first fixation member 10, and a second circuit board 40.

Please refer again to FIG. 4. As shown in the figure, according to the present embodiment, the first fixation member 10 is disposed on one side of the first circuit board 20. A second hole 26 is disposed on the same side of the first circuit board 20. A first locking slot 18 is disposed in an inner side of the first fixation member 10. A first output terminal 13 is disposed on an inner side of the first locking slot 18. According to the present embodiment, the first locking slot 18 is connected pivotally to the inside of the first fixation member 10 using one or more pivot member 19. One end of the second circuit board 40 is inserted to an inner side of the first locking slot 18. A first input terminal 44 is disposed on the end of the second circuit board 40. The first input terminal 44 is connected electrically to the first output terminal 13. A first fixation cut-opening 47 is disposed on the top of the second circuit board 40 and corresponding to the location of the second hole 26 of the board member 1 for subsequent fixation.

According to the present embodiment, a heating device 46 is disposed on one side of the second circuit board 40. The heating device 46 is connected electrically to the second circuit board 40 for receiving electrical energy and the control signal, and forming a structure of thermal printing head fixed by the structure according to the present embodiment. The first circuit board 20 can be a printed circuit board (PCB) according to the prior art.

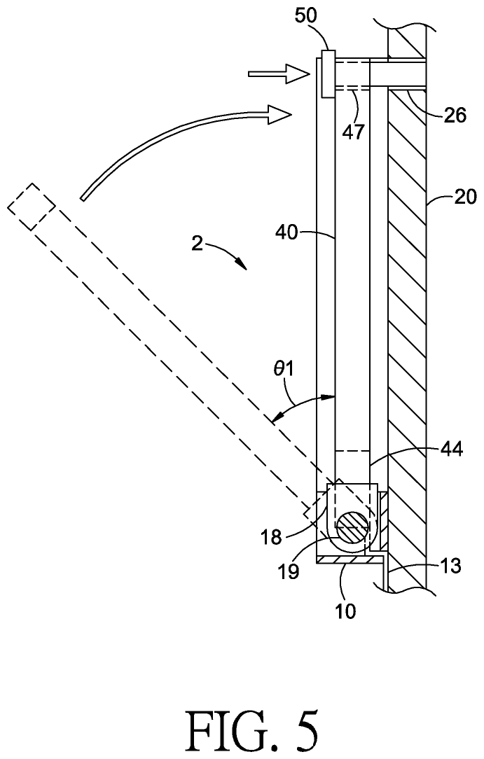

Please refer to FIG. 4 again and refer to FIG. 5. FIG. 5 shows a schematic diagram of the operation according to the second embodiment of the present application, As shown in the figures, according to the present embodiment, one end of the second circuit board 40 is inserted to the inside of the first locking slot 18 at an angle θ1.

Since the first locking slot 18 is connected pivotally to the inside of the first fixation member 10, the first locking slot 18 can rotate. The first locking slot 18 rotates after the first circuit 20 is inserted and thus driving the second circuit board 40 to move. Then the first fixation cut-opening 47 of the second circuit board 40 is moved corresponding to the location of the first hole 26. The present embodiment further comprises a first screw member 50, which first passes through the first fixation cut-opening 47. After the first fixation cut-opening 47 is moved to corresponding to the first hole 26, the first screw member 50 passes through the first fixation cut-opening 47 and the first hole 26 for providing fixation. The location of the second circuit board 40 is limited, preventing it from arbitrary movement. In addition, by providing the angled installation method, a user can install the second circuit board 40 conveniently in a narrow space.

According to the present embodiment, the first fixation member 10 is disposed on one side of the first circuit board 20. The first locking slot 18 is connected pivotally to the first fixation member 10. The second circuit board 40 is inserted to the first locking slot 18. By using the rotation of the first locking slot 18 and fixation to the second circuit board 40, an angled installation method is provided and hence facilitating a user to install the second circuit board 40 conveniently in a narrow space.

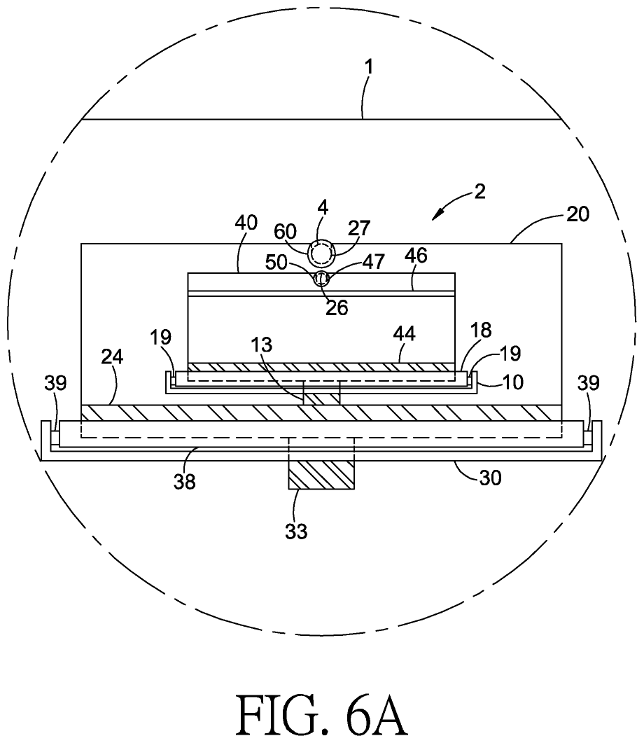

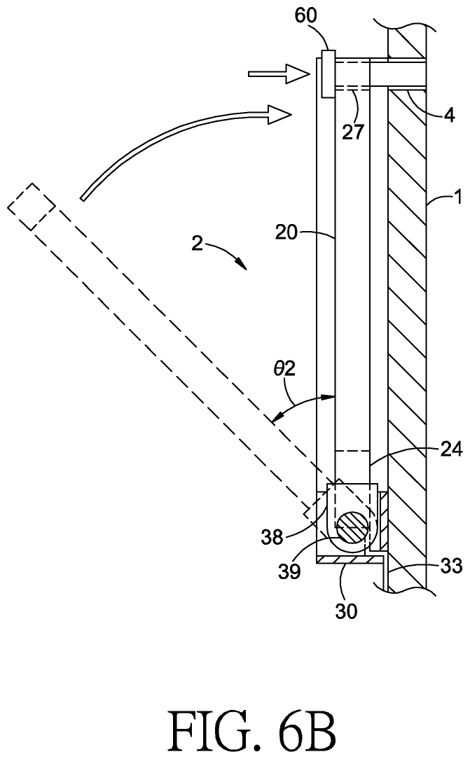

Please refer to FIG. 5 again and refer to FIG. 6A. FIG. 6A shows a schematic diagram of the structure of the second fixation member according to the second embodiment of the present application. As shown in the figures, the present embodiment is based on the structure according to the above embodiment. A second hole 4 is disposed on one side of a board member 1, which can be the lid of the printer according to the prior art. A second fixation member 30 is disposed on one side of the board member 1. In other words, the second fixation member 30 is disposed on one side of the board member 1. A second locking slot 38 is connected pivotally to an inner side of the second fixation member 30. According to the present embodiment, like the structure according the above embodiment, the second locking slot 38 is connected pivotally to the inside of the second fixation member 30 using one or more pivot member 39. One end of the first circuit board 20 is inserted to an inner side of the second locking slot 38. A second fixation cut-opening 27 is disposed on the top of the first circuit board 20 and corresponds to the location of the second hole 4. The present embodiment further comprises a second screw member 60, which first passes through the second fixation cut-opening 27. After the second fixation cut-opening 27 is moved to corresponding to the second hole 4, the second screw member 60 passes through the second fixation cut-opening 27 and the second hole 4 for providing fixation. The location of the first circuit board 20 is limited, preventing it from arbitrary movement.

Please refer to FIGS. 5 and FIG. 6A again and to FIG. 6B. FIG. 6B shows a schematic diagram of the operation of the second fixation member according to the second embodiment of the present application. As shown in the figures, the operation according to the present embodiment is the same as the previous embodiment. As shown in FIG. 6A, according to the present embodiment, the first circuit board 20 corresponds to the board member 1; the second fixation member 20 corresponds to the first fixation member 10; the second locking slot 38 corresponds to the first locking slot 18; and the second circuit board 40 corresponds to the first circuit board 20. The first circuit board 20 is inserted to the inside of the second locking slot 38 at an angle θ2. The heating device 46 moves along with the second circuit board 40. The first hole 26 corresponds to the second hole 4. Since the above main devices have their corresponding devices, the operation of the devices will not be described again. The devices according to the present embodiment are duplicated from the ones according to the above embodiment and shrunk before installing on the first circuit board 20. Hence, the purpose of converting small-sized circuit boards to large ones can be achieved.

A first input terminal 44 is disposed on one end of the second circuit board 40 and connected electrically to the second circuit board 40. The first input terminal 44 is disposed corresponding to an inner side of the second locking slot 38 and connected electrically to a first output terminal 13. One end of the first circuit board 20 is disposed corresponding to the first output terminal 13 and connected electrically to a second input terminal 24. The board member 1 is disposed corresponding to the second input terminal 24 and connected electrically to a second output terminal 33. The control signal of the thermal printer is transmitted sequentially from the second output terminal 33 to the second input terminal 24, the first output terminal 13, and the first input terminal 44 for controlling the heating device 46 of the second circuit board 40. Then the signals on the large-sized first circuit board 20 can be adapted to the small-sized second circuit board 40. Thereby, the thermal printer can adapt to different sizes of circuit boards.

According to the present embodiment, the second fixation member 30 is disposed on one side of the board member 1. The second locking slot 38 is connected pivotally to the second fixation member 30. The first circuit board 20 is inserted to the second locking slot 38. By using the rotation of the second locking slot 38 and fixation to the first circuit board 20, an angled installation method is provided and hence facilitating a user to install the first circuit board 20 conveniently in a narrow space.

To sum up, the present application provides a fixation structure for thermal printing head, which uses the first fixation member, two limited members, and two protruded members on one side of the first circuit board to provide a structure for installing the second circuit board rapidly. Then the problem of complicated and time-consuming steps for installing circuit boards, such as thermal printing heads, occurred in the prior art can be solved. The present application further comprises the first locking slot connected pivotally on an inner side of the first fixation member. The rotatable first locking slot provides a structure for rapid installation of the second circuit board. The angled installation method facilitates a user to install the second circuit board in a narrow space. While solving the problem of complicated and time-consuming steps for installing circuit boards according to the prior art, the present application also enables a user to install circuit board in a narrow printer space. The present application further uses the first and second input terminals and the first and second output terminal to transmit signals for achieving the efficacy of converting a small-sized circuit board to a large one.

Accordingly, the present application conforms to the legal requirements owing to its novelty, nonobviousness, and utility. However, the foregoing description is only embodiments of the present application, not used to limit the scope and range of the present application. Those equivalent changes or modifications made according to the shape, structure, feature, or spirit described in the claims of the present application are included in the appended claims of the present application.

What is claimed is:

1. A fixation structure for a thermal printing head, comprising:
a first circuit board;
a first fixation member, disposed on one side of said first circuit board, a first slot formed between said first fixation member and said first circuit board, a first output terminal disposed on an inner side of said first slot, a first limited member disposed on one end of said first fixation member, a second limited member disposed on the other end of said first fixation member, a first protruded member disposed slidably on the top of said first limited member facing said second limited member, and a second protruded member disposed slidably on the top of said second limited member facing said first limited member; and
a second circuit board, disposed between said first limited member and said second limited member, one end of said second circuit board inserted in said first slot of said first fixation member, a first input terminal disposed on said first input terminal and connected electrically to said first output terminal;
where said second circuit board sliding down to a top of said first fixation member from the space between a top of said first limited member and a top of said second limited member, said first protruded member and said second protruded member sliding in the direction facing a board member to be against a top of said first circuit board, and said first output terminal transmitting a control signal to said first input terminal.

2. The fixation structure for the thermal printing head of claim 1, wherein a heating device is disposed on one side said second circuit board, and said heating device is connected electrically to said first input terminal and receives said control signal.

3. The fixation structure for the thermal printing head of claim 1, wherein fixation structure for the thermal printing head is disposed on one side of a board member, and further comprising:
a second fixation member, disposed on one side of said board member, a second slot formed between said second fixation member and said board member, a third limited member disposed on one end of said second fixation member, a fourth limited member disposed on the end of said second fixation member, a third protruded member disposed slidably on the top of said third limited member facing said fourth limited member, a fourth protruded member disposed slidably on the top of said fourth limited member facing said third limited member, and said first circuit disposed between said third limited member and said fourth limited member and inserted to said second slot of said second fixation member.

4. The fixation structure for the thermal printing head of claim 3, where a second input terminal is disposed at a bottom of said first circuit board; a second output terminal is disposed in said second slot; said second input terminal is connected electrically to said second output terminal; said control signal is transmitted sequentially from said second output terminal to said second input terminal, from said second input terminal to said first output terminal, and from said first output terminal to said first input terminal.

5. A fixation structure for a thermal printing head, comprising:
a first circuit board, having a first hole on one side;
a first fixation member, disposed on one side of said first circuit board, a first locking slot connected pivotally to an inner side of said first fixation member; and a first output disposed on an inner side of said first locking slot; and
a second circuit board, one end of said second circuit board inserted to an inner side of said first locking slot, a first fixation cut-opening disposed on a top of said second circuit board and corresponding to the location of said first hole, a first input terminal disposed on said end of said second circuit board, and said first input terminal connected electrically to said first output terminal;
where said second circuit boards is inserted to said inner side said first locking slot at an angle; said first locking slot rotates on said inner side of said first fixation member to move said second circuit boards and enabling said first fixation cut-opening be corresponding to said first hole; and said first output terminal transmits a control signal to said first input terminal.

6. The fixation structure for the thermal printing head of claim 5, further comprising one or more pivot member, and said first locking slot connected pivotally to said inner side of said first fixation member using said one or more pivot member.

7. The fixation structure for the thermal printing head of claim 5, wherein a heating device is disposed on one side said second circuit board, and said heating device is connected electrically to said first input terminal and receives said control signal.

8. The fixation structure for the thermal printing head of claim 5, further comprising a first screw member passing through said first fixation cut-opening and said first hole.

9. The fixation structure for the thermal printing head of claim 8, disposed on one side of said board member, and further comprising:
a second fixation member, disposed on one side of said board member, and a second locking slot connected pivotally to said second fixation member; and
a first circuit board, inserted to an inner side of said second locking slot, and a second fixation cut-opening disposed on a top of said first circuit board and corresponding to the location of said second hole.

10. The fixation structure for the thermal printing head of claim 9, where a second input terminal is disposed at a bottom of said first circuit board; a second output terminal is disposed in said second locking slot; said second input terminal is connected electrically to said second output terminal; said control signal is transmitted sequentially from said second output terminal to said second input terminal, from said second input terminal to said first output terminal, and from said first output terminal to said first input terminal.

11. The fixation structure for thermal printing head of claim 9, further comprising a second screw member passing through said second fixation cut-opening and said second hole.
